(19) United States
(12) Patent Application Publication
(10) Pub. No.: US 2026/0370650 A1
(43) Pub. Date: Nov. 19, 2026

(54) CENTRALIZED DOCUMENT MANAGEMENT WITH METADATA INTEGRATION

(71) Applicant: THE HUNTINGTON NATIONAL BANK, Columbus, OH (US)

(72) Inventors: Gregory Files, Columbus, OH (US); Veer Murukutla, Columbus, OH (US)

(73) Assignee: THE HUNTINGTON NATIONAL BANK, Columbus, OH (US)

(21) Appl. No.: 19/209,407

(22) Filed: May 15, 2025

(51) Int. Cl. H04L 9/40; G06F 3/0486; G06F 40/166

(52) U.S. Cl. CPC H04L 63/105; G06F 3/0486; G06F 40/166; H04L 63/083; H04L 63/123

(57) ABSTRACT

Techniques are described herein for centralized document management with metadata integration. A software application can receive an indication of a document related to an entity identifiable using an entity identifier. The software application can retrieve metadata associated with the entity based on the entity identifier and from one or more data sources. The software application can determine, based on access privileges of a user profile associated with the software application, whether to store the document and the retrieved metadata in a central repository. In response to determining to store the document and the retrieved metadata in the central repository, the software application can perform a transfer process by which the document and the retrieved metadata are stored in the central repository.

### TECHNICAL FIELD

This application generally relates to data storage and management, and more particularly to systems, methods, and non-transitory, computer-readable media to implement centralized document management with metadata integration.

### BACKGROUND

A centralized database system can be used to store one or more files such that the files are accessible by multiple users. Each file can include a respective set of metadata or metainformation. Metadata generally refers to data that provides information about other data, such as descriptive information or structural information of a particular file. In some cases, at least a portion of the metadata can be provided by or obtained from distributed or heterogeneous data sources.

### BRIEF SUMMARY

Techniques are provided for centralized document management with metadata integration. Various embodiments are described herein, including methods, systems, non-transitory computer-readable storage media storing programs, code, or instructions executable by one or more processors, and the like.

One embodiment is directed to a computer-implemented method for centralized document management with metadata integration. The method can include receiving, by a software application, an indication of a document related to an entity identifiable using an entity identifier. The method additionally can include retrieving, by the software application based on the entity identifier and from a plurality of data sources, metadata associated with the entity. The method can further include determining, by the software application based on access privileges of a user profile associated with the software application, whether to store the document and the retrieved metadata in a central repository. The method can include, in response to determining to store the document and the retrieved metadata in the central repository, performing, by the software application, a transfer process by which the document and the retrieved metadata are stored in the central repository.

In some embodiments, a system includes one or more processors and one or more memories storing computer-executable instructions that, when executed by the one or more processors, causes the one or more processors to perform one or more operations. The operations can include receiving, by a software application, an indication of a document related to an entity identifiable using an entity identifier. The operations can additionally include retrieving, by the software application based on the entity identifier and from a plurality of data sources, metadata associated with the entity. The operations can further include determining, by the software application based on access privileges of a user profile associated with the software application, whether to store the document and the retrieved metadata in a central repository. The operations can include, in response to determining to store the document and the retrieved metadata in the central repository, performing, by the software application, a transfer process by which the document and the retrieved metadata are stored in the central repository.

In some embodiments, a non-transitory computer-readable storage medium storing computer-executable instructions that, when executed with one or more processors of a computing device, causes the computing device to perform one or more operations. The operations can include receiving, by a software application, an indication of a document related to an entity identifiable using an entity identifier. The operations can additionally include retrieving, by the software application based on the entity identifier and from a plurality of data sources, metadata associated with the entity. The operations can further include determining, by the software application based on access privileges of a user profile associated with the software application, whether to store the document and the retrieved metadata in a central repository. The operations can include, in response to determining to store the document and the retrieved metadata in the central repository, performing, by the software application, a transfer process by which the document and the retrieved metadata are stored in the central repository.

### BRIEF DESCRIPTION OF THE DRAWINGS

Various embodiments in accordance with the present disclosure will be described with reference to the drawings, in which:

FIG. 1 is an example flow for centralized document management with metadata integration, in accordance with at least one embodiment;

FIG. 2 is an example block diagram illustrating an example system implementing centralized document management with metadata integration, in accordance with at least one embodiment;

FIG. 3 is an example block diagram illustrating example user interfaces, in accordance with at least one embodiment;

FIG. 4 is a block diagram illustrating an example method for determining whether access privileges of a user are compatible with one or more content types, in accordance with at least one embodiment;

FIG. 5 is a schematic diagram of an example computer architecture for a document management system, including a plurality of modules that may perform functions in accordance with at least one embodiment;

FIG. 6 is a block diagram illustrating an example method for implementing centralized document management with metadata integration, in accordance with at least one embodiment; and

FIG. 7 illustrates an example computing device that may implement the methods disclosed herein.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described herein are directed to centralized document management with metadata integration. In some embodiments, techniques are described for determining whether a user of a document management system is authorized to access certain content types of documents stored in a central repository. In some examples, the document management system can implement access control to restrict certain users to access specific content types. Techniques are also described with respect to retrieving metadata from one or more data sources such that the metadata can be integrated with a document to be stored in the central repository. Various embodiments are described herein, including methods, systems, non-transitory computer-readable storage media storing programs, code, or instructions executable by one or more processors, and the like. The programs, code, or instructions can be executable to cause one or more operations to be performed.

Some or all of the processes described herein (or variations and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program including a set of instructions executable by one or more processing devices. The computer-readable storage medium may be non-transitory.

The disclosed techniques disclosed herein provide improvements to a transfer of a document from a source application to a central repository. The disclosed methods can include a more streamlined process compared to conventional processes. For example, the disclosed methods can enable a document to be transferred directly from the source application storing the document to the central repository. In some conventional processes, the document is first transferred to another location before being provided to the central repository. For example, the document may be downloaded from an email client before being provided to the central repository. As another example of streamlining the transfer of the document, the disclosed methods can combine a set of documents together such that the set of documents can be stored together in the central repository, which can reduce a number of transfers performed. In particular, instead of separately transferring each document in the set of documents to the central repository, the set of documents can be stored in the central repository using a single transfer process.

Additionally, the disclosed techniques described herein provide improvements to digital identification and organization. The document management system described herein can retrieve metadata related to an entity from one or more data sources. The document management system can perform this retrieval process for each document to be stored in the central repository. Additionally, the document management system can automatically populate the retrieved metadata for presentation to a user of the document management system, which can enable the user to review or correct the retrieved metadata. In some examples, the document management system may use different communication channels or protocols to communicate with each data source to retrieve the metadata. Additionally, the document management system can standardize the metadata that can be retrieved from different data sources. For example, each data source may store or provide a respective portion of the metadata in a different format, which can hinder integration of the metadata with the document. The document management system can process the retrieved metadata to ensure that the metadata is in a data format suitable for storing in the central repository or as part of the document.

Further, the disclosed techniques described herein provide improvements to access control with respect to storing different types of documents in the central repository. In some examples, a user that interacts with the document management system to store a document may have limited access to certain content types. For example, access privileges of the user may indicate that the user is prohibited from accessing confidential information. As another example, the access privileges of the user can prevent the user from storing documents in a folder of the central repository that corresponds to confidential information. To prevent unauthorized modifications to the folder, the document management system can implement access control with respect to access privileges of the user. In some examples, the document management system can use a user identifier related to or identifying the user to determine the access privileges of the user. In some cases, the document management system can obtain the user identifier as part of a single sign-on process such that the user can forgo entering the user identifier multiple times.

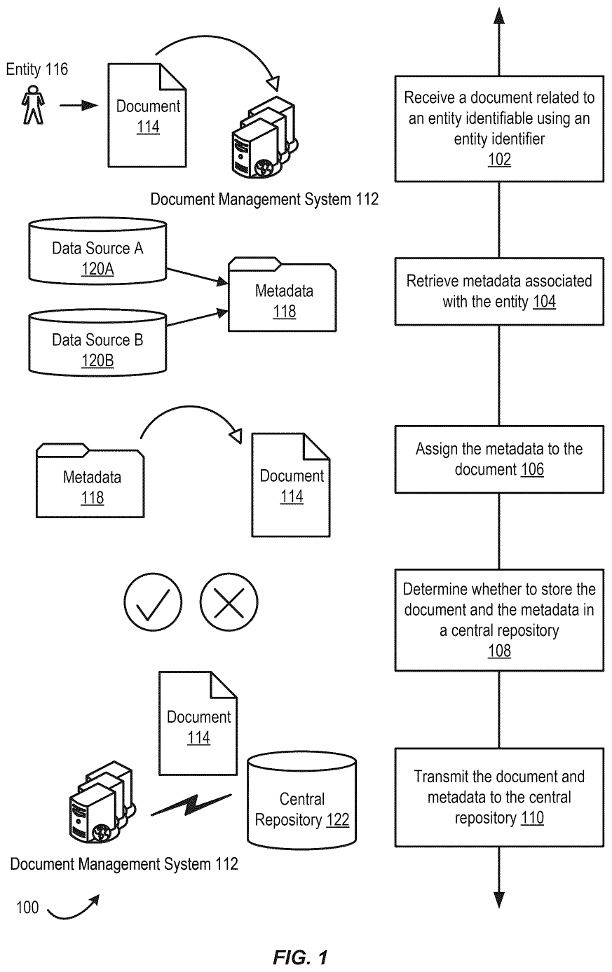

Moving on to FIG. 1 which illustrates an example flow 100 for an example flow for centralized document management with metadata integration, in accordance with at least one embodiment. The operations discussed in connection with FIG. 1 may be performed with a document management system 112. In some embodiments, the document management system 112 can be a software application or another suitable computer program. In some embodiments, the document management system 112 can be a web-based application that can run via a web browser. In some embodiments, the document management system 102 may be implemented by one or more computer(s), as a service, within an application, or the like. The operations discussed in connection with FIG. 1 may be performed in any suitable order. More or fewer operations than those depicted in FIG. 1 may be employed without diverting from this disclosure.

The flow 100 may begin at 102, where the document management system 112 can receive an indication of a document 114 related to an entity 116 identifiable using an entity identifier. In some embodiments, the entity 116 can be a person, a company, or an organization. For example, the document 114 can be an application including information related to the entity 116 to request certain protected resources. In some embodiments, the protected resources can be provided to the entity 116 on a temporary basis. For example, the entity 116 may use a specific amount of the protected resources within a month. The entity 116 can be expected to return an equivalent amount of the protected resources during the following month. Accordingly, the protected resources can be borrowed or lent to the entity 116. In some embodiments, a quantity of the protected resources accessible by the entity can be determined based on the information provided by the entity via the document 114. In some embodiments, a verification process can be performed based on the information provided in the application to determine whether the entity has a suitable access level to access the protected resources.

In some embodiments, more than one document can be provided by the entity 116 to request access to the protected resources. For example, a respective subset of documents provided by the entity 116 can provide information related to different aspects of the entity 116. By way of example, a particular subset of documents can provide information related to historical usage by the entity 116 of the protected resources. To facilitate organization or retrieval, each document provided by or related to the entity 116 can be identifiable using the entity identifier. In some embodiments, the entity identifier can be a unique identifier of the entity 116. In some embodiments, the entity identifier can be a sequence of characters (e.g., numbers, letters, symbols, or a combination thereof). The entity identifier can have a predefined length or a predefined number of characters.

In some embodiments, the document management system 112 can be in communication with a user device that can receive user input from a user. In some embodiments, the user of the document management system 112 can be different from the entity 116. For example, the user can perform at least a portion of the verification process to determine whether to enable the entity 116 to access the protected resources. The user device can be any suitable computing device, such as a laptop, desktop, mobile device, tablet, etc. In some embodiments, the user input can provide instructions to the user device to transmit the document 114 or a representation of the document 114 to the document management system 112. For example, the user may interact with an input device (e.g., a mouse, keyboard, touchscreen, etc.) of the user device to initiate a drag operation to move an icon corresponding to the document 114 from a starting location to a destination location. In other words, drag operation can be initiated by user input. For example, the drag operation can involve moving or translating the icon from a first user interface of a source application to a second user interface of the document management system 112. As another example, once the icon corresponding to the document 114 is moved to the destination location, the user can interact with the input device to initiate a drop operation that can complete the drag operation. In some embodiments, once the drag operation is completed, the document management system 112 can receive a message or other suitable communication related to the document 114. For example, the document management system 112 can receive communication from the source application identifying the document 114, such as by providing a document name, document type, or other suitable document metadata.

The flow 100 may continue at block 104, where the document management system 112 can retrieve metadata 118 associated with the entity 116 based on the entity identifier. In some embodiments, the metadata 118 can include information that describes the entity 116. For example, the metadata 118 can include one or more personal identifiers (e.g., a name of the entity 116) that can identify the entity 116. As another example, the metadata 118 can include one or more resource identifiers that can identify one or more resources associated with the entity 116. Examples of the resources can include physical objects or properties associated with the entity 116. In some embodiments, the metadata 118 can be used to determine whether to provide the entity 116 with the protected resources.

In some embodiments, the document management system 112 may receive a portion of the metadata 118 (e.g., as part of the indication of the document 114). The document management system 112 then can retrieve a remaining portion of the metadata 118. In some embodiments, one or more portions of the metadata 118 can be stored in various locations or data sources. For example, as shown in FIG. 1, the metadata 118 can be retrieved from a first data source 120A and a second data source 120B. In some embodiments, each data source can store different types of metadata 118. For example, the first data source 120A may store a subset of the metadata 118 related to a vehicle of the entity 116. As another example, the second data source 120B may store a different subset of the metadata 118 related to a property (e.g., real estate) of the entity 116. In some embodiments, each data source may store a respective type of metadata based on security risk or access permissions associated with the respective type of metadata. For example, a data source storing Social Security numbers may have more security protocols in place compared to a different data source storing vehicle identification numbers.

The flow 100 may continue at block 106, where the document management system 112 can assign the metadata 118 to the document 114. In some embodiments, once the metadata 118 is retrieved, the document management system 112 can populate a user interface to display the metadata 118 to the user, such as to allow the user to verify the metadata 118 retrieved from the data sources 120A-B. In some embodiments, the document management system 112 can assign the metadata 118 to the document 114 by integrating the metadata 118 with the document 114. For example, the document management system 112 can automatically populate one or more fields of the document 114 with the metadata 118 retrieved from heterogeneous or distributed data sources.

The flow 100 may continue at block 108, where the document management system 112 can determine whether to store the document 114 and the metadata 118 in a central repository 122. In some embodiments, the central repository 122 can function as a centralized storage system to store one or more documents that can correspond to one or more entities. The central repository 122 can enable the user or other users to retrieve a particular document to perform one or more tasks. For example, another user may provide an entity identifier of a particular entity as part of a retrieval request to retrieve corresponding or related documents from the central repository. In some embodiments, the central repository 122 can be in communication with one or more computing modules, applications, engines, programs, or other suitable computing components. These computing components can communicate with the central repository 122 to retrieve a particular document to perform one or more jobs or tasks.

In some embodiments, the document management system 112 can validate the document 114 to determine whether a mandatory type of metadata has been retrieved, such as at block 104. If the mandatory type of metadata is missing, the document management system 112 may prevent the document 114 and the metadata 118 from being stored in the central repository 122. In some embodiments, the document management system 112 may output an alert or another suitable notification on a user interface of the document management system 112 to indicate to the user that the mandatory type of metadata is missing. On the other hand, if the mandatory type of metadata is present in the metadata 118 assigned to the document 114, the document management system 112 may allow the document 114 and the metadata 118 to be stored in the central repository 122.

In some embodiments, the document management system 112 can determine whether to store the document 114 and the metadata 118 in the central repository 122 based on one or more access privileges of a user profile associated with the user. In some embodiments, the access privileges can indicate a set of content types modifiable or accessible by the user associated with the user profile. For example, the access privileges can indicate that the user has permission to modify certain content types while being restricted from accessing other content types. In some embodiments, if the document 114 has a content type that the user is not permitted to modify or access, the document management system 112 may prevent or forgo storing the document 114 and the metadata 118 in the central repository 122. On the other hand, if the content type of the document 114 is consistent with the access privileges of the user, the document management system 112 may store the document 114 and the metadata 118 in the central repository 122.

In some embodiments, access to the document management system 112 can be restricted based on login credentials inputted by the user. The login credentials can include a user identifier (e.g., a username) that can correspond to the user profile and can be used to determine the access privileges of the user. Additionally, the login credentials can include a password or another suitable authentication factor to verify an identity of the user. In some embodiments, access control techniques, such as role-based access control, can be implemented to restrict access to the document management system 112. By way of example, the user identifier can indicate a role corresponding to the user profile of the user that can be used to determine the access privileges of the user. In some implementation, the role can indicate or be associated with one or more tasks to be performed by the user and corresponding access privileges to perform the tasks.

The flow 100 may continue at block 110, where, based on determining to store the document 114 and the metadata 118 in the central repository 122, the document management system 112 transmits the document 114 and the metadata 118 assigned to the document 114 to the central repository 122. In some embodiments, the document management system 112 can be in communication with the central repository 122, such as via a network (e.g., a wide area network (WAN), a local area network (LAN), etc.). Other types of wireless or wired communication can be possible to communicatively couple the document management system 112 and the central repository 122. In some embodiments, the document management system 112 can be in communication with the source application that can store or otherwise provide the document 114. In some embodiments, the document management system 112 can communicate with the source application to obtain a copy of the document 114 based on a drag operation and a drop operation initiated by the user. For example, once the drop operation is initiated or detected, the document management system 112 can transmit a retrieval request to the source application via a communication protocol. The retrieval request can identify the document requested by the document management system 112. Once the document management system 112 receives the copy of the document 114, the document management system 112 can communicate with the central repository 122 to store the copy of the document 114 in the central repository 122. Other implementations are possible. For example, the document management system 112 may communicate with the source application such that the source application provides the copy of the document directly to the central repository 122.

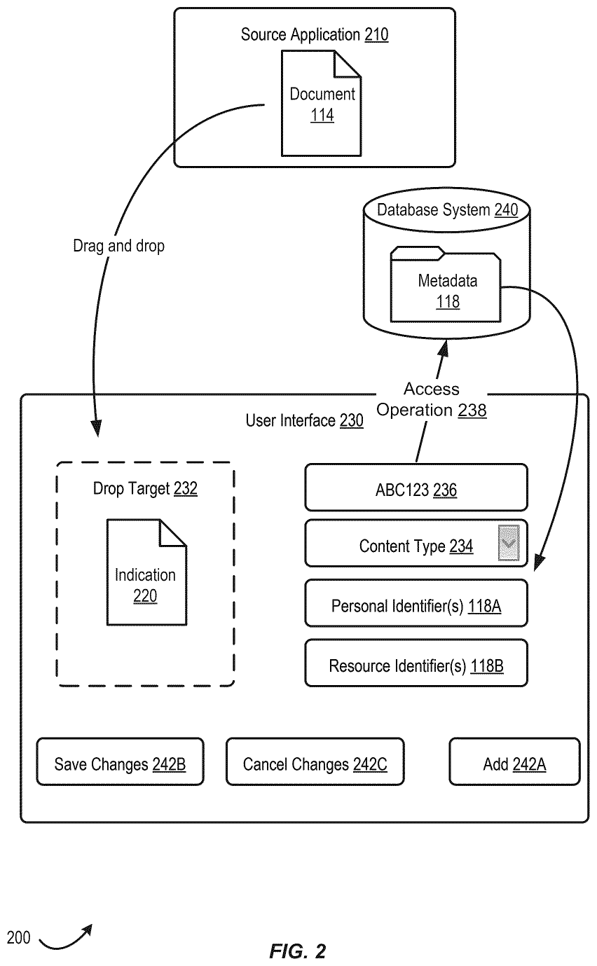

FIG. 2 is an example block diagram illustrating an example system 200 implementing centralized document management with metadata integration, in accordance with at least one embodiment. Certain aspects of FIG. 2 are described below with reference to components of FIG. 1. As shown in FIG. 2, a source application 210 can store or host a document 114 that can include information related to an entity (e.g., the entity 116 of FIG. 1). In some embodiments, the source application 210 can be a software application or another suitable computer program executed or run on a computing device associated with a user. For example, the source application 210 can include an email client or mail user agent that can enable a user to access or manage electronic mail. The user can interact with the source application 210, such as using an input device of the computing device. As another example, the source application 210 can be a database or a file system that can store the document 114.

In some embodiments, the user can initiate a drag operation to move or transfer the document 114 or an indication 220 of the document 114 from a starting location corresponding to the source application 210 to a destination location corresponding to a document management system (e.g., the document management system 112 of FIG. 1). For example, the indication 220 of the document 114 can include an icon (e.g., a pictogram or an ideogram) that can represent the document 114. In some embodiments, the indication 220 of the document 114 can function as a hyperlink or a file shortcut that can enable access to the document 114 by selecting or activating the indication 220. As shown in FIG. 2, the destination location can be a user interface 230 of the document management system. In some implementations, the source application 210 can include a separate user interface that can display an interface element as the indication 220 representing or corresponding to the document 114. By way of example, the user can interact with a mouse communicatively coupled with the computing device to select the interface element corresponding to the document 114 in the source application 210 and move the interface element to the user interface 230. In some embodiments, the user can initiate a drop operation that can indicate a release of the interface element at the destination location (e.g., the user interface 230). The drop operation can correspond to a termination or completion of the drag operation. In some implementations, the user interface 230 of the document management system 112 can include a drop target 232 that can indicate a region of the user interface 230 to which to move the interface element. For example, the user can initiate the drop operation by releasing the interface element after the interface element is positioned within the user interface 230 or within the drop target 232 of the user interface 230. In some embodiments, once the drop operation is initiated, the user interface 230 can be updated to include the indication 220 of the document 114 in the drop target 232.

In some embodiments, completing the drag operation can cause the document management system 112 to perform one or more operations based on the document 114. Although the document management system 112 is described herein as performing the operations based on the drag operation, it will be appreciated that the document 114 or the indication 220 of the document 114 can be transferred to the user interface 230 in other ways. For example, the user interface 230 can include a file input component that can allow the user to attached one or more files or documents. In some embodiments, the operations can include determining a content type 234 of the document 114. The content type 234 can facilitate organization or sorting of the document 114 in the central repository 122. For example, the content type 234 can indicate a category of the document 114. As another example, the content type 234 can indicate whether the document 114 is a new version of an existing document. In some embodiments, the document management system can receive user input that can indicate the content type 234. For example, as shown in FIG. 2, the user interface 230 can include a dropdown menu that the user can interact with to select the content type 234. Once a content type 234 is selected, the content type 234 can be referred to as a selected content type. In some embodiments, the document management system can determine the content type 234 based on document metadata associated with the document 114. In some implementations, the document management system can apply a rule set that can determine the content type 234 using a file name of the document 114. By way of example, the rule set can map a specific sequence of characters (e.g., a word or a phrase) to a corresponding content type 234.

In some embodiments, once the drag operation is completed, the document management system can retrieve metadata 118 associated with the entity related to the document 114. In some embodiments, the document management system may receive (e.g., via user input from the user) an entity identifier 236 that can identify the entity. For example, the document management system can receive a sequence of keystrokes at the user interface 230 as part of the user input that can indicate the entity identifier 236. In some embodiments, the document management system may determine the entity identifier 236 based on the document 114, such as using a file name of the document 114 or other suitable document metadata. The document management system can output the entity identifier 236 for presentation to the user, such as to enable the user to verify or modify the entity identifier 236. As shown, the metadata 118 can include one or more personal identifiers 118A and one or more resource identifiers 118B. Non-limiting examples of the personal identifiers 118A can include a first name, a last name, a national identification number, a state identification number, etc. Non-limiting examples of the resource identifiers 118B can include a vehicle identification number, an address, etc.

As shown in FIG. 2, in some embodiments, the document management system can perform an access operation 238 based on the entity identifier 236 to retrieve metadata 118 from a database system 240. The database system 240 can include one or more databases that may each store a respective type of the metadata 118. The document management system can perform the access operation 238 with respect to at least one data source or database of the database system 240. In some embodiments, the document management system can be communicatively coupled with the database system 240, such as via a network. In some embodiments, the access operation can include calling one or more application programming interface (API) calls. In some embodiments, the access operation 238 can include performing a lookup operation. In some embodiments, the document management system can automatically populate at least a portion of the metadata 118 retrieved using the access operation 238 in the user interface 230. For example, as shown in FIG. 2, the user interface 230 can include one or more text fields that can output for presentation to the user the metadata 118 retrieved from the database system 240.

In some embodiments, transferring the indication of the document 114 from the source application 210 to the user interface 230 of the document management system 112 can initiate a transfer of the document 114 from the source application 210 to the central repository 122. In some embodiments, performing the transfer of the document 114 to the central repository 122 can occur once the user interface 230 receives user input selecting a first button 242A of the user interface 230. For example, selection of the first button 242A can execute instructions to cause the document management system to communicate with the source application 210 to transfer the document 114 to the central repository 122. In some embodiments, the user interface 230 can include one or more additional buttons that can be selected by the user. For example, as shown in FIG. 2, the user interface 230 can include a second button 242B that can be selected by the user to cause the document management system 112 to save data included in the user interface 230 at a time corresponding to the selection of the second button 242B. The document management system 112 can save changes made by the user to the user interface 230, such as user input modifying or providing metadata 118 to be assigned to the document 114. Although the user interface 230 is described as having buttons 242A-C, it will be appreciated that other types of selectable interface elements are possible.

In some examples, retrieving the metadata 118 as described herein can be part of this transfer of the document 114 to the central repository 122. In some embodiments, the transfer of the document 114 to the central repository 122 can involve validating the document 114. For example, the document management system 112 can validate the document 114 by determining whether a file type of the document 114 is acceptable. Certain file types may be unreadable or otherwise unaccepted by the document management system 112 or the central repository 122. The document management system 112 can determine the file type of the document 114 using a file extension that can be included as part of a file name of the document 114. Based on determining that the file type of the document 114 is unacceptable or otherwise unsuitable, the document management system can prevent or forgo the transfer of the document 114 to the central repository 122. Additionally, the document management system 112 can output an alert or notification via the user interface 230 to notify the user. Based on determining that the file type of the document 114 is acceptable, the document management system 112 can proceed with the transfer of the document 114 to the central repository 122. In some embodiments, the document management system 112 may perform one or more additional operations prior to performing or completing the transfer of the document 114 to the central repository 122.

As another example, the document management system 112 can validate the document 114 by determining whether the entity identifier 236 is valid. In some embodiments, the document management system 112 can identify a set of valid entity identifiers and compare the entity identifier 236 to the set of valid entity identifiers. For example, the document management system 112 can maintain a list of valid entity identifiers that can include historical entity identifiers previously used to store documents in the central repository. In some examples, the document management system 112 can implement pattern matching or other suitable string searching techniques to compare the entity identifier 236 to the set of valid entity identifiers. If a match does not exist between the entity identifier 236 and the set of valid entity identifiers, the document management system 112 may determine that the entity identifier 236 is invalid. Based on determining that the entity identifier 236 is invalid, the document management system 112 can prevent or forgo the transmission or transfer of the document 114 to the central repository 122. On the other hand, if a match is determined to exist between the entity identifier 236 and a particular valid entity identifier of the set of valid entity identifiers, the document management system 112 can determine that the entity identifier 236 is valid. Based on determining that the entity identifier 236 is valid, the document management system 112 can allow the transmission of the document 114 to the central repository 122.

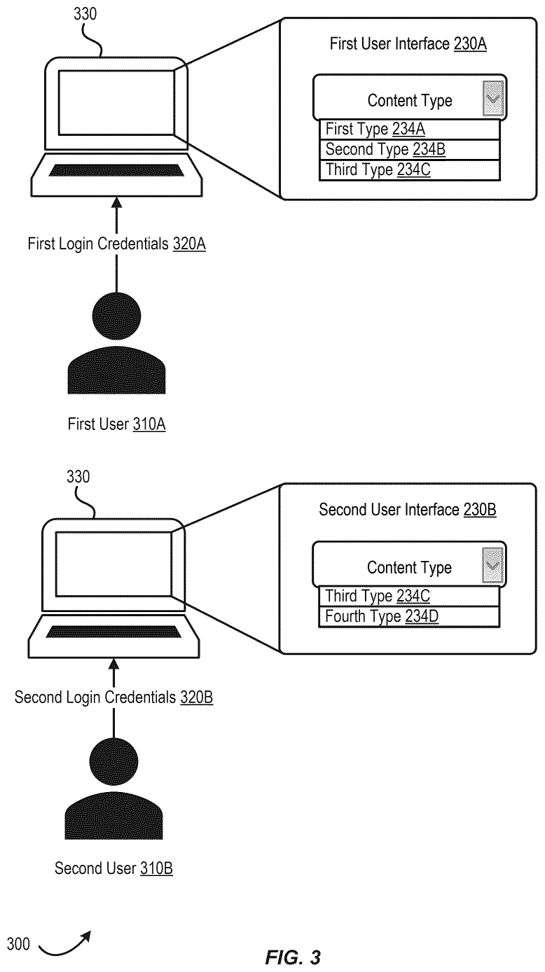

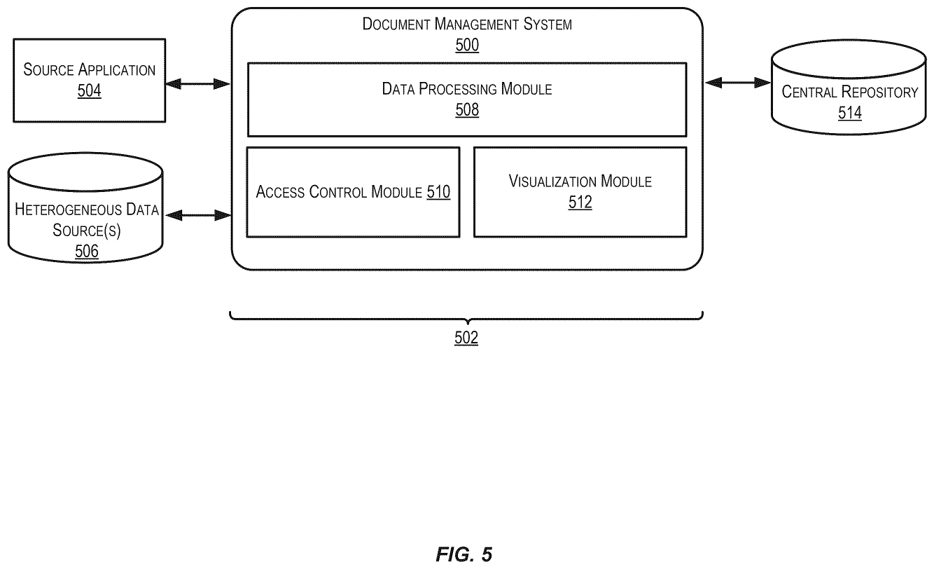

FIG. 3 is an example block diagram illustrating example user interfaces 230A-B, in accordance with at least one embodiment. In some embodiments, the user interfaces 230A-B can part of a document management system (e.g., the document management system of FIG. 1 or FIG. 5). The user interfaces 230A-B can be outputted for presentation to one or more users 310. In some embodiments, each user can be associated with a corresponding set of login credentials 320. Each set of login credential 320 can be unique to the corresponding user. Based on a particular set of login credentials inputted at a user device 330, the user interface 230 can be modified. Certain aspects of FIG. 3 are described below with reference to components of a preceding figure, such as FIG. 2.

As shown in FIG. 3, a first user 310A can provide a first set of login credentials 320A to the user device 330. Although the user device 330 is shown in FIG. 3 as a computer, it will be appreciated that other types of computing devices (e.g., mobile devices) are possible. In some embodiments, the first user 310A can input the first set of login credentials 320A as part of a login process to obtain access to an operating system or other software components of the user device 330. The user device 330 can validate the first set of login credentials to determine whether the first user 310A can access the software components. In some embodiments, the first user 310A can input the first set of login credentials 320A as part of a login process to access the document management system, such as a document upload portion of the document management system. A second user 310B similarly can provide a second set of login credentials 320B to the user device 330 to access software components of the user device 330 or to access the document management system.

In some embodiments, each set of login credentials 320 can include a respective user identifier that can correspond to a respective user profile of a corresponding user. Examples of the user identifier can include a username or an email address of the corresponding user. For example, the document management system can use a first username provided as part of the first set of login credentials 320A to identify or locate a first user profile of the first user 310A. Similarly, the document management system can use a second username provided as part of the second set of login credentials 320B to identify a second user profile corresponding to the second user 310B.

In some embodiments, the document management system can use the user identifier of the user 310 to determine access privileges or permissions associated with the user 310. For example, determining the access privileges corresponding to a particular user identifier can be part of a login process to access the document management system. Each user can have a respective set of access privileges. In some implementations, the document management system can implement access control, such as role-based access control, to define the respective set of access privileges of each user. As an example, the document management system can use the first user identifier to determine a role associated with a first user profile of the first user 310A. The document management system then can determine a specific set of access privileges corresponding to the role of the first user 310A. In some embodiments, users that share the same role can have the same set of access privileges.

In some embodiments, the access privileges of each user can indicate a respective set of content types modifiable or accessible by each user. In some implementations, the central repository can include organization implemented by categorizing each document stored in the central repository with a specific content type. For example, the central repository can include one or more buckets or groups that each include documents of a corresponding content type. The document management system can implement access control to restrict access to certain content types based on the access privileges of each user. In some embodiments, restricting access can include preventing a user 310 from adding or modifying documents of a specific content type. In some embodiments, the document management system can determine each set of content types 234 of the users 310A-B using a respective set of access privileges determined using a respective user identifier provided as part of the sets of login credentials 320A-B.

In some embodiments, the document management system can implement access control by modifying a respective user interface presented to each user or to users having different sets of access privileges. In some embodiments, based on each set of login credentials 320, the document management system can output a respective user interface for presentation to the corresponding user. For example, based on the first user identifier, the document management system can generate and output a first user interface 230A specific to the first user 310A. The first user interface 230A can include access to a first set of content types 234 by the first user 310A. For example, as shown in FIG. 3, the first user interface 230A can include a dropdown menu having a first content type 234A, a second content type 234B, and a third content type 234C selectable or available for selection by the first user 310A. The content types 234A-C can be referred to as selectable content types or selectable options for the first user 310A. Similarly, the document management system can provide a second user interface 230B different from the first user interface 230A for presentation to the second user 310B. In particular, the second user interface 230B can differ from the first user interface 230A in that the first set of content types 234 of the first user interface 230A is different from a second set of content types 234 provided as part of the second user interface 230B. For example, as shown in FIG. 3, the second set of content types 234 includes the third content type 234C and a fourth content type 234D that can be selectable content types for the second user 310B. Accordingly, based on a second set of access privileges corresponding to the second user 310B, the document management system may forgo providing the second user 310B access to the first content type 234A and the second content type 234B as selectable options.

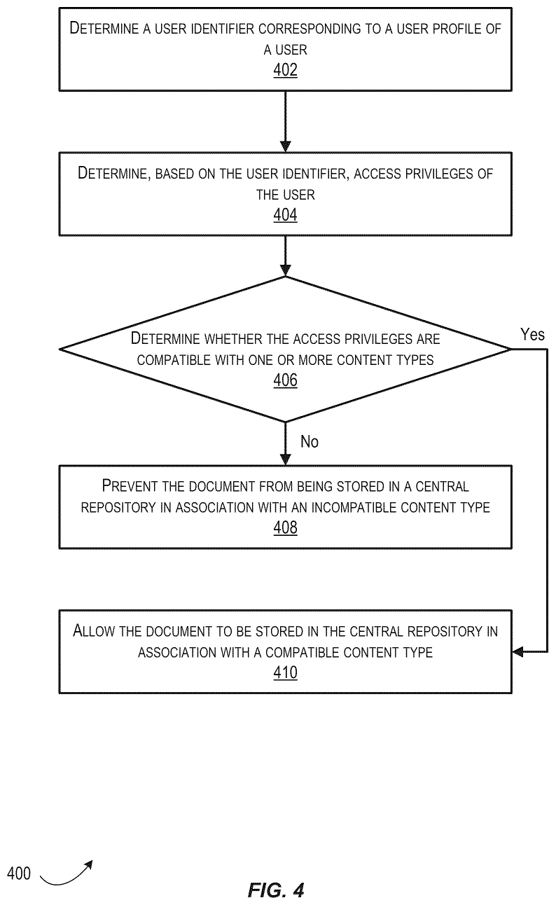

FIG. 4 is a block diagram illustrating an example method 400 for determining whether access privileges of a user are compatible with one or more content types, in accordance with at least one embodiment. A non-transitory computer-readable storage medium may store computer-executable instructions that, when executed by at least one processor, cause at least one computer to perform instructions comprising the operations of the method 400. It should be appreciated that the operations of the method 400 may be performed in any suitable order, not necessarily the order depicted in FIG. 4. Further, the method 400 may include additional, or fewer operations than those depicted in FIG. 4. The operations of method 400 may be performed by any suitable portion the document management system 102 of FIG. 1. In some embodiments, method 400 may be executed by components of the document management system 500 of FIG. 5.

The method 400 may begin at block 402, where the document management system determines a user identifier corresponding to a user profile of a user. As an example, the user identifier can be a sequence of characters (e.g., letters, numbers, or a combination thereof) that is provided or set by the user. As another example, the user identifier can be assigned to the user. In general, the user identifier can be a unique identifier of the user. In some embodiments, the user may provide the user identifier as part of a login process. For example, the user may provide the user identifier to log in to access a document upload component of the document management system. As another example, the user can provide the user identifier as part of a single sign-on authentication process by which the user can access multiple software applications or programs using a single set of login credentials.

As described herein, in some embodiments, the user identifier can be a sequence of characters that the document management system can use to determine the user profile. In some embodiments, each user identifier maps to a corresponding user profile. For example, the document management system can access a database or a table storing one or more mappings that each link a respective user identifier to the corresponding user profile. In some embodiments, the user profile can include a collection of information related to the user. For example, the user profile can indicate a role or a security group of the user that can be used to determine access privileges of the user. Other information can be included as part of the user profile, such as information related to behavior or preferences of the user.

The method 400 may continue at block 404, where the document management system determines, based on the user identifier, the access privileges of the user. In some embodiments, the document management system can determine the access privileges of the user based on the user profile determined using the user identifier. For example, the user profile can include a security group to which the user belongs or is assigned. Each security group can have a corresponding set of access privileges. Using the user identifier, the document management system can determine the security group of the user and the corresponding set of access privileges, thereby identifying the access privileges of the user.

The method 400 may continue at block 406, where the document management system determines whether the access privileges of the user are compatible with one or more content types. In some embodiments, the central repository can store or organize its contents using the content types. For example, each document stored in the central repository can be assigned a respective content type by the document management system. The central repository can include one or more groups of documents where each group corresponds to a respective content type. For example, each document in a particular group can be assigned the same content type. In some embodiments, the access privileges of the user can indicate which content types the user is authorized or allowed to access or modify. In some embodiments, modifying a content type can include uploading or storing a document designated with the content type.

The method 400 may continue at block 408, where the document management system prevents the document from being stored in a central repository in association with an incompatible content type. In some embodiments, the incompatible content type can be associated with a security level that exceeds or is outside of the access privileges afforded to the user. For example, the incompatible content type can correspond to confidential information that is protected or restricted based on governmental regulations. In some embodiments, the document management system can forgo presenting the incompatible content type to the user in a user interface. For example, if the access privileges of the user are incompatible with a particular content type, the document management system can present a user interface that lacks the particular content type. Accordingly, the user can be prevented from selecting the incompatible content type to assign to the document.

The method 400 may continue from block 406 at block 408, where the document management system allows the document to be stored in the central repository in association with a compatible content type. In some embodiments, the access privileges of the user may indicate that the user is allowed to access or modify more than one content type. In some embodiments, the document management system can present the compatible content type as a selectable interface element in the user interface displayed to the user. For example, the document management system can provide each compatible content type as part of a dropdown menu of the user interface. Once the user provides user input to select a compatible content type, the document management system can assign the compatible content type to the document. For example, the compatible content type can be stored with the document in the central repository as document metadata.

FIG. 5 is a schematic diagram of an example computer architecture for a document management system 500, including a plurality of modules 502 that may perform functions in accordance with at least one embodiment. The document management system 500 can be configured to support the processes, methods, operations, and techniques described herein, such as with respect to FIGS. 1-4 and FIG. 6. The modules 502 may be software modules, hardware modules, or a combination thereof. If the modules are software modules, the modules can be embodied on a computer readable medium and processed by a processor or a processing device in any of the computer systems described herein. It should be noted that any module or data store described herein, may be, in some embodiments, be a service responsible for providing functionality corresponding to the module described below. The modules 502 may be executed as part of the document management system 500, or the modules 502 may exist as separate modules or services external to the document management system 500. In some embodiments, the modules 502 may be executed by the same or different computing devices, as a service, as an application, or the like.

In the embodiment shown in the FIG. 5, data sources such as a source application 504 and one or more heterogeneous data sources 506 are shown, although data can be maintained, derived, or otherwise accessed from various data stores, either remote or local to the document management system 500, to achieve the functions described herein. The document management system 500, as shown in FIG. 5, includes various modules such as a data processing module 508, an access control module 510, and a visualization module 512. Some functions of the modules 508-512 are described below. A brief, non-limiting description of each of the modules is provided in the following paragraphs. In accordance with at least one embodiment, a process of centralized document management with metadata integration is provided.

In at least one embodiment, the source application 504 can be a software application or program that can include a document to be uploaded or stored in a central repository 514. For example, the source application 504 can be an electronic mail client that a user can use to transmit and receive communication that can include one or more documents. In some embodiments, the document management system 500 can function as an intermediary between the source application 504 and the central repository 514. For example, the document management system 500 can receive the document or an indication of the document from the source application 504. Once the document management system 500 receives the document or the indication of the document, the document management system 500 can retrieve metadata related to an entity associated with the document. For example, the entity can submit information as part of the document to request one or more protected resources. In some embodiments, the document management system 500 can integrate the retrieved metadata with the document such that the document and the metadata can be stored in the central repository 514. In some embodiments, the retrieved metadata can be stored separately from the document in the central repository 514, such as in a metadata registry or a metadata repository of the central repository 514.

In at least one embodiment, the heterogeneous data sources 506 can include one or more databases or external entities that can provide information related to one or more entities that can provide the documents to be stored in the central repository. The heterogeneous data sources 506 can provide metadata related to the entity of the document received by the document management system 500 from the source application 504. Examples of the external entities can include credit bureaus, government entities, etc. By way of example, the data provided by the heterogeneous data sources 506 can be with respect to housing of the entities or other possessions of the entities. In some embodiments, each data source or a portion of the heterogeneous data sources 506 can provide its information in a different data format or using a different communication channel. Examples of the data format can include an unstructured format (e.g., text) or a structured format (e.g., a table). Examples of the communication channel can include an API call or a lookup operation.

In at least one embodiment, the document management system 500 includes the data processing module 508. Generally, the data processing module 508 may be utilized to receive or retrieve any suitable information with respect to any example provided herein. In some embodiments, the data processing module 508 can be configured to receive the document or the indication of the document from the source application 504. For example, the data processing module 508 can be in communication with the visualization module 512 that can generate a user interface at which the document or the indication of the document is received.

In some embodiments, the data processing module 508 may be configured to retrieve the metadata from the heterogeneous data sources 506. For example, the data processing module 508 can perform different calls or operations based on a respective communication channel of each data source of the heterogeneous data sources 506 to retrieve the metadata. In some embodiments, the data processing module 508 may receive one or more portions of the metadata in different formats. For example, a first portion of the metadata retrieved from a first data source may have a different format than a remaining portion of the metadata retrieved from a second data source. In some embodiments, the data processing module 508 can convert the first portion of the metadata, the remaining portion of the metadata, or a combination thereof to have a consistent or standardized format. In some embodiments, the standardized format can be suitable for storage in the central repository 514 or otherwise compatible with the central repository 514. For example, if the first portion of the metadata is compatible for storage in the central repository 514, the data processing module 508 may forgo converting a data format of the first portion of the metadata.

In at least one embodiment, the document management system 500 includes the access control module 510. Generally, the access control module 510 can be used to implement access control to certain content types of the central repository 514. For example, the access control module 510 can determine access privileges of a user of the document management system 500 based on a user identifier of the user. As described herein, the user identifier can be provided as part of login credentials inputted by the user to gain access to the document management system 500, such as a document upload component of the user interface generated by the visualization module 512. In some embodiments, the access control module 510 can include or access a database that can map the user identifier to a user profile that can include a corresponding role or security group. Each role or security group can be associated with a corresponding set of access privileges. The access control module 510 then can query or search the database using the user identifier to determine the corresponding set of access privileges of the user.

In at least one embodiment, the document management system 500 includes the visualization module 512. Generally, the visualization module 512 can be used to generate or update the user interface presented to the user of the document management system 500. For example, the access privileges of the user can affect which interface elements are presented as part of the user interface. The visualization module 512 may generate and output different user interfaces to users that have different access privileges. As described above with respect to FIG. 3, the visualization module 512 can generate a first user interface 230A to present to a first user 310A that differs from a second user interface 230B presented to a second user 310B in the selectable content types 234. As another example, the document management system 500 may determine, such as using the access control module 510, that the user lacks suitable access privileges to upload documents to the central repository 514. The visualization module 512 then can output a user interface to the user that prevents the user from submitting documents to the central repository 514. For example, the user interface may lack a button (e.g., the button 242A of FIG. 2) that proceeds with a transfer process of a document from the source application 504 to the central repository 514.

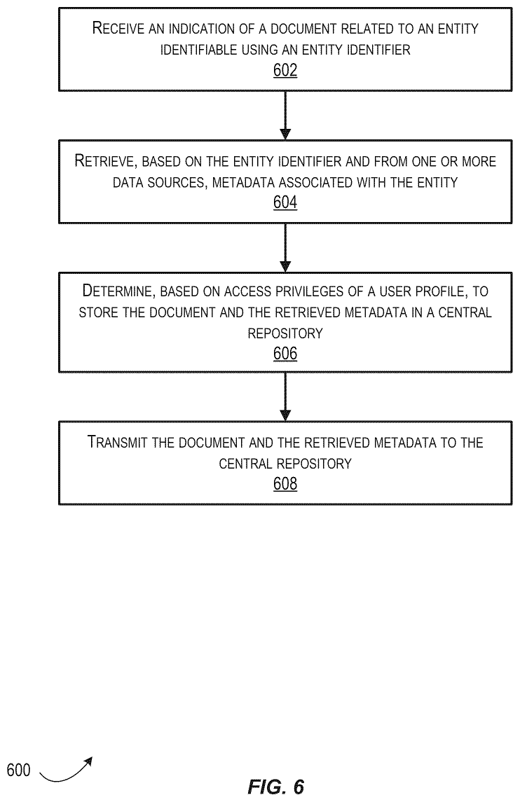

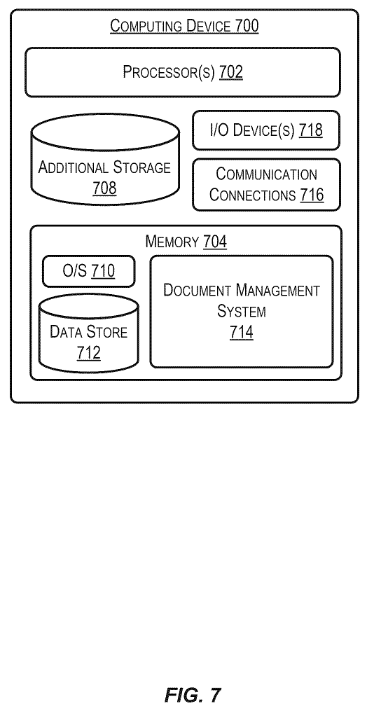

FIG. 6 is a block diagram illustrating an example method 600 for implementing centralized document management with metadata integration, in accordance with at least one embodiment. A non-transitory computer-readable storage medium may store computer-executable instructions that, when executed by at least one processor, cause at least one computer to perform instructions comprising the operations of the method 600. It should be appreciated that the operations of the method 600 may be performed in any suitable order, not necessarily the order depicted in FIG. 6. Further, the method 600 may include additional, or fewer operations than those depicted in FIG. 6. The operations of method 600 may be performed by any suitable portion of the document management system 500 of FIG. 5 which may include one or more computing devices such as computing device 700 of FIG. 7.

The method 600 may begin at block 602, where the document management system receives an indication of a document related to an entity identifiable using an entity identifier. As described herein, the entity (e.g., the entity 116 of FIG. 1) can be a person, a company, a corporation, or an organization. The entity identifier can function as a unique identifier of the entity. In some embodiments, the entity identifier can correspond to a specific request of the entity. For example, the entity can submit documentation to request access to one or more protected resources (e.g., processing power, storage, exchange media, etc.). In some embodiments, the documentation can include a document submitted to initiate a resource request. In some embodiments, the documentation can include one or more additional documents that can support the resource request, such as to be used in a determination of whether to grant the resource request such that the entity can access the protected resources. For example, the additional documents can indicate an existing quantity of resources associated with the entity. As another example, the additional documents can indicate a historical usage of resources associated with the entity.

In some embodiments, the document management system can receive the indication of the document based on one or more operations performed with respect to a user interface of the document management system. For example, the document management system can detect a drag operation indicating a transfer of an interface element corresponding to the document from a source application to the user interface of the document management system. The drag operation can be initiated by user input indicating a starting location of the interface element at the source application and a destination location of the interface element at the user interface of the document management system. Subsequent to detecting the drag operation, the document management system can detect a drop operation indicating a release of the interface element corresponding to the document at the destination location. By way of example, a user of the document management system may operate an input device to select the interface element at the starting location and translate the selected interface element from the starting location to the destination location. The user then can operate the input device to release or deselect the interface element once the interface element is positioned at or approximate to the destination location.

The method 600 may continue at block 604, where the document management system retrieves, based on the entity identifier and from one or more data sources, metadata (e.g., the metadata 118 of FIG. 1 and FIG. 2) associated with the entity. In some embodiments, the document management system can receive user input that can include the entity identifier corresponding to the document. In some embodiments, subsequent to receiving the user input, the document management system can perform an access operation to retrieve the metadata using the entity identifier provided in the user input. For example, the document management system can perform a lookup operation using the entity identifier to search a database or another suitable data source and retrieve a portion of the metadata. In some embodiments, the document management system may perform the access operation in response to detecting the drop operation. For example, the drop operation can correspond to a termination or an end of the drag operation. Once the metadata is retrieved, the document management system can populate at least a portion of the retrieved metadata in a user interface of the document management system. As another example, the document management system can pass the entity identifier to a particular data source as part of an API call. The data source can respond to the API call with a portion of the metadata related to the entity identifier. In some embodiments, the metadata associated with the entity can be retrieved from multiple data sources. For example, the document management system may perform a respective access operation to access each data source to obtain a respective portion of the metadata. Once each portion of the metadata is retrieved, the document management system can process the metadata to integrate the metadata as part of the document or for storage in a central repository (e.g., the central repository of FIG. 1 or FIG. 5).

The method 600 may continue at block 606, where the document management system determines, based on access privileges of a user profile, to store the document and the retrieved metadata in the central repository. As described herein, the document management system can determine a user profile of a user of the document management system based on a user identifier related to the user. For example, the user identifier can be provided as part of login credentials inputted to access the document management system. The user profile can include information related to the user, such as the access privileges of the user. Based on the access privileges, the document management system can determine a set of content types modifiable or accessible by the user associated with the user profile. In some embodiments, the document management system can provide each content type of the set of content types for presentation as a selectable option in a user interface of the document management system. For example, the user interface can include a dropdown menu listing each content type of the set of content types. In response to receiving user input selecting a particular selectable option, the document management system can assign the corresponding content type to the document.

In some embodiments, certain users may lack sufficient or suitable access privileges to access a document upload component of the document management system. For example, the document management system can determine that the access privileges associated with the user profile are incompatible with a particular content type of the document. In response to determining that the access privileges are incompatible with the document, the document management system can prevent the document from being stored in the central repository in association with the incompatible content type. For example, the document management system can forgo presentation of the incompatible content type to the user via the user interface. Accordingly, the user can be unable to select the incompatible content type in the user interface or otherwise associate the incompatible content type with the document.

The method 600 may continue at block 606, where the document management system performs a transfer process by which the document and the retrieved metadata are stored in the central repository. In some embodiments, the transfer process can involve transferring the document and the metadata from the document management system to the central repository. For example, the document management system may have previously received the document from the source application. In some embodiments, the transfer process can involve the document management system communicating with the source application such that the source application transfers the document directly to the central repository. As an example, the document management system may include the retrieved metadata as part of its communication to the source application such that the source application can transmit the retrieved metadata with the document for storage in the central repository.

In some embodiments, the document management system may perform a validation process with respect to the entity identifier prior to performing the transfer process. For example, the document management system can receive user input that includes or otherwise indicate the entity identifier corresponding to the document. The document management system can validate the document by determining whether the entity identifier is valid. For example, the document management system can compare the entity identifier received as part of the user input with a set of valid entity identifiers stored in a database system. Based on the received entity identifier matching an entity identifier of the valid entity identifiers, the document management system can determine that the received entity identifier is valid. The document management system then may proceed with the transfer process of the document to the central repository. Conversely, if the document management system fails to or is unable to identify a matching entity identifier in the valid entity identifiers, the document management system may determine that the received entity identifier is invalid. The document management system then can prevent the transfer process of the document to the central repository.

FIG. 7 illustrates an example computing device 700 that may implement the methods disclosed herein. In some embodiments, the computing device 700 may include one or more processors (e.g., processor(s) 702). The processor(s) 702 may be implemented in hardware, computer-executable instructions, firmware, or combinations thereof. Computer-executable instruction or firmware implementations of the processor(s) 702 may include computer-executable or machine-executable instructions written in any suitable programming language.

Computing device 700 may include memory 704. The memory 704 may store computer-executable instructions that are loadable and executable by the processor(s) 802, as well as data generated during the execution of these programs. The memory 704 may be volatile (such as random-access memory (RAM)) and/or non-volatile (such as ROM, flash memory, etc.). The computing device 700 may include additional storage 706, which may include removable storage and/or non-removable storage. The additional storage 706 may include, but is not limited to, magnetic storage, optical disks and/or tape storage. The disk drives and their associated computer-readable media may provide non-volatile storage of computer-readable instructions, data structures, program modules, and other data for the computing devices. In some implementations, the memory 704 or additional storage 706 may individually, or collectively, include multiple different types of memory, such as SRAM, DRAM, or ROM.

The memory 704 and/or additional storage 708 may be examples of computer-readable storage media. Computer-readable storage media may include volatile, or non-volatile, removable or non-removable media implemented in any method or technology for storage of information such as computer-readable instructions, data structures, program modules, or other data. In some embodiments, memory 704 and the additional storage 708 are examples of computer storage media. Memory 704 and/or additional storage 708 may include, but are not limited to, PRAM, SRAM, DRAM, RAM, ROM, EEPROM, flash memory or other memory technology, CD-ROM, DVD, magnetic tape, magnetic disk storage or other magnetic storage devices, or any other medium which can be used to store the desired information and which can be accessed by the computing device 700. Combinations of any of the above should also be included within the scope of computer-readable media. Computer-readable media may include computer-readable instructions, program modules, or other data transmitted within a data signal, such as a carrier wave, or other transmission. However, as used herein, computer-readable storage media does not include computer-readable communication media.

The memory 704 may include an operating system 710 and one or more data stores 712, and/or one or more application programs, modules, or services for implementing the features disclosed herein, such as the features provided by the document management system 714 (an example of the document management system 500 of FIG. 5).

The computing device may also contain communications connection(s) 716 that allow the computing device 700 to communicate with a stored database, another computing device, a server, user terminals and/or other devices (e.g., via one or more networks, not depicted). The computing device may also include I/O device(s) 718, such as a keyboard, a mouse, a pen, a voice input device, a touch input device, a display, speakers, a printer, etc.

The various embodiments further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C #, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random-access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

As a non-limiting example, the document management system described herein (e.g., the document management system 500 of FIG. 5) can be used in financial applications. As described herein, the document management system can facilitate a transfer of a document from a source application to a central repository. An entity can provide the document as part of a resource request to obtain certain protected resources. For example, the document can be part of an application filled out by the entity to obtain a loan. In some examples, the document management system can assign an application identifier to the resource request as an entity identifier that can be used to identify the entity initiating the resource request. In other examples, the application identifier may have been previously assigned to the entity, such as in relation to the resource request or another suitable application to obtain certain protected resources. For example, the document to be transferred to the central repository can be a supplemental document indicating an income of the entity that is submitted after the entity initiates the resource request. Using the application identifier, the document management system can perform one or more access operations to obtain metadata related to the entity, such as a Social Security number or a vehicle identification number of a vehicle owned by the entity. In some examples, the document management system can include this metadata with the document stored in the central repository.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method, comprising:
detecting, by a software application, a drag operation indicating a transfer of an interface element corresponding to a document, the transfer occurring from a source application to a user interface of the software application, wherein the drag operation is initiated by user input indicating a starting location of the interface element at the source application and a destination location of the interface element at the user interface of the software application;
subsequent to detecting the drag operation, detecting, by the software application a drop operation indicating a release of the interface element at the destination location;
receiving, by the software application, an indication of the document related to an entity identifiable using an entity identifier;
retrieving, by the software application based on the entity identifier and from a plurality of data sources, metadata associated with the entity by performing a respective access operation based on a respective communication channel of each data source of the plurality of data sources, the metadata comprising a set of metadata values, wherein at least a portion of the plurality of data sources provides a respective portion of the set of metadata values in a different format;
determining, by the software application based on access privileges of a user profile associated with the software application, whether to store the document and the retrieved metadata in a central repository; and
in response to determining to store the document and the retrieved metadata in the central repository, performing, by the software application, a transfer process by which the document and the retrieved metadata are stored in the central repository.

2. The computer-implemented method of claim 1, wherein retrieving the metadata associated with the entity comprises:
receiving user input that comprises the entity identifier corresponding to the document;
subsequent to receiving the user input, performing a lookup operation with respect to at least one data source of the plurality of data sources using the entity identifier provided in the user input; and
automatically populating the set of metadata values retrieved using the lookup operation in a respective text field of the user interface of the software application.

3. (canceled)

4. The computer-implemented method of claim 1, wherein the metadata is retrieved from the plurality of data sources in response to detecting the drop operation.

5. The computer-implemented method of claim 1, further comprising:
receiving user input that comprises the entity identifier corresponding to the document;
validating the document by determining whether the entity identifier is valid; and
based on determining that the entity identifier is invalid, preventing the transfer process of the document to the central repository.

6. The computer-implemented method of claim 1, wherein determining whether to store the document and the metadata in the central repository further comprises:
determining a user identifier corresponding to the user profile, wherein the user identifier is provided as part of login credentials inputted to access the software application; and
determining, based on the user identifier, the access privileges, wherein the access privileges indicate a set of content types modifiable by a user associated with the user profile.

7. The computer-implemented method of claim 6, further comprising:
based on the access privileges, providing each content type of the set of content types for presentation as a selectable option in the user interface of the software application; and
in response to receiving user input indicating a selection of a particular selectable option, assigning the selected content type to the document.

8. The computer-implemented method of claim 6, wherein determining whether to store the document and the metadata in the central repository further comprises:
determining that the access privileges are incompatible with a particular content type of the document; and
in response to determining that the access privileges are incompatible with the particular content type of the document, preventing the document from being stored in the central repository in association with the incompatible content type.

9. The computer-implemented method of claim 1, wherein the entity identifier corresponds to a request initiated by the entity to access one or more protected resources.

10. A system, comprising:
one or more processors; and
one or more memories storing computer-executable instructions that, when executed by the one or more processors, causes the one or more processors to:
detect, by a software application, a drag operation indicating a transfer of an interface element corresponding to a document, the transfer occurring from a source application to a user interface of the software application, wherein the drag operation is initiated by user input indicating a starting location of the interface element at the source application and a destination location of the interface element at the user interface of the software application;
subsequent to detecting the drag operation, detect, by the software application a drop operation indicating a release of the interface element at the destination location;
receive, by the software application, an indication of the document related to an entity identifiable using an entity identifier;
retrieve, by the software application based on the entity identifier and from a plurality of data sources, metadata associated with the entity by performing a respective access operation based on a respective communication channel of each data source of the plurality of data sources, the metadata comprising a set of metadata values, wherein at least a portion of the plurality of data sources provides a respective portion of the set of metadata values in a different format;
determine, by the software application based on access privileges of a user profile associated with the software application, whether to store the document and the retrieved metadata in a central repository; and
in response to determining to store the document and the retrieved metadata in the central repository, perform, by the software application, a transfer process by which the document and the retrieved metadata are stored in the central repository.

11. The system of claim 10, wherein retrieving the metadata associated with the entity comprises:
receiving user input that comprises the entity identifier corresponding to the document;
subsequent to receiving the user input, performing a lookup operation with respect to at least one data source of the plurality of data sources using the entity identifier provided in the user input; and
automatically populating the set of metadata values retrieved using the lookup operation in a respective text field of the user interface of the software application.

12. (canceled)

13. The system of claim 10, wherein the metadata is retrieved from the plurality of data sources in response to detecting the drop operation.

14. The system of claim 10, wherein the computer-executable instructions are further executable to cause the one or more processors to:
receive user input that comprises the entity identifier corresponding to the document;
validate the document by determining whether the entity identifier is valid; and
based on determining that the entity identifier is invalid, prevent the transfer process of the document to the central repository.

15. The system of claim 10, wherein determining whether to store the document and the metadata in the central repository further comprises:
determining a user identifier corresponding to the user profile, wherein the user identifier is provided as part of login credentials inputted to access the software application; and
determining, based on the user identifier, the access privileges, wherein the access privileges indicate a set of content types modifiable by a user associated with the user profile.

16. The system of claim 15, wherein the computer-executable instructions are further executable to cause the one or more processors to:
based on the access privileges, provide each content type of the set of content types for presentation as a selectable option in the user interface of the software application; and
in response to receiving user input indicating a selection of a particular selectable option, assign the selected content type to the document.

17. The system of claim 15, wherein determining whether to store the document and the metadata in the central repository further comprises:
determining that the access privileges are incompatible with a particular content type of the document; and
in response to determining that the access privileges are incompatible with the particular content type of the document, preventing the document from being stored in the central repository in association with the incompatible content type.

18. The system of claim 10, wherein the entity identifier corresponds to a request initiated by the entity to access one or more protected resources.

19. A non-transitory computer-readable storage medium storing computer-executable instructions that, when executed with one or more processors of a computing device, causes the computing device to:
detect, by a software application, a drag operation indicating a transfer of an interface element corresponding to a document, the transfer occurring from a source application to a user interface of the software application, wherein the drag operation is initiated by user input indicating a starting location of the interface element at the source application and a destination location of the interface element at the user interface of the software application;
subsequent to detecting the drag operation, detect, by the software application, a drop operation indicating a release of the interface element at the destination location;
receive, by the software application, an indication of the document related to an entity identifiable using an entity identifier;
retrieve, by the software application based on the entity identifier and from a plurality of data sources, metadata associated with the entity by performing a respective access operation based on a respective communication channel of each data source of the plurality of data sources, the metadata comprising a set of metadata values, wherein at least a portion of the plurality of data sources provides a respective portion of the set of metadata values in a different format;
determine, by the software application based on access privileges of a user profile associated with the software application, whether to store the document and the retrieved metadata in a central repository; and
in response to determining to store the document and the retrieved metadata in the central repository, perform, by the software application, a transfer process by which the document and the retrieved metadata are stored in the central repository.

20. The non-transitory computer-readable storage medium of claim 19, wherein retrieving the metadata associated with the entity comprises:
receiving a user input that comprises the entity identifier corresponding to the document;
subsequent to receiving the user input, performing a lookup operation with respect to at least one data source of the plurality of data sources using the entity identifier provided in the user input; and
automatically populating the set of metadata values retrieved using the lookup operation in a respective text field of the user interface of the software application.

21. The computer-implemented method of claim 1, wherein the document comprises information related to the entity and used to request a protected resource, and wherein the metadata is used to determine whether to provide the entity with the protected resource.

22. The computer-implemented method of claim 1, further comprising, subsequent to detecting the drop operation indicating the release of the interface element at the destination location:
determining a content type of the document based on document metadata of the document; and
storing the document and the retrieved metadata in the central repository in association with the content type, wherein the central repository comprises one or more sets of documents corresponding to a respective content type.
